(19) United States
(12) Patent Application Publication
(10) Pub. No.: US 2011/0277592 A1
(43) Pub. Date: Nov. 17, 2011

(54) SEPARATION METHOD FOR CARRIER-FREE RADIOLANTHANIDES

(75) Inventors: Cathy S. Cutler, Columbia, MO (US); Stacy L. Wilder, Harrisburg, MO (US); Mary F. Embree, Columbia, MO (US)

(73) Assignee: THE CURATORS OF THE UNIVERSITY OF MISSOURI, Columbia, MO (US)

(21) Appl. No.: 13/127,743

(22) PCT Filed: Nov. 6, 2009
(86) PCT No.: PCT/US09/63513

§ 371 Date: Jul. 12, 2011

Related U.S. Application Data
(60) Provisional application No. 61/198,729, filed on Nov. 6, 2008.

(51) Int. Cl. C22B 59/00

(52) U.S. Cl. 75/393; 75/711

(57) ABSTRACT

A method for separating a lanthanide from a mixture containing at least one other lanthanide is provided. In particular, an HPLC and liquid separation method using a chromatographic column for separating a lanthanide from a mixture containing at least one other lanthanide is provided.

### FIELD OF THE INVENTION

This application document relates to methods of separating lanthanides from a mixture of two or more different lanthanide elements. More specifically, this document relates to HPLC and liquid chromatographic methods of separating two or more different lanthanides from a mixture of different lanthanide elements.

### BACKGROUND OF THE INVENTION

Radioactive isotopes of lanthanide elements, also known as radiolanthanides, are used with great success in medical imaging and radiopharmaceutical applications. For example, radiolanthanides known to kill or damage living cells may be attached to a guiding system that recognizes receptor sites over-expressed on cancer cells, and used to provide targeted radiotherapy. The efficacy of the therapeutic compositions containing radiolanthanides depends in part on the specific activity of the therapeutic composition, defined herein as the amount of radioactivity per unit mass of the composition. A key factor driving the specific activity of therapeutic compositions containing radiolanthanides is the purity of the radiolanthanide samples used to produce the composition relative to contaminants such as parent isotopes or other byproducts of the process used to produce the radiolanthanide sample.

Producing high-purity radiolanthanide samples for use in a therapeutic composition is a challenging issue. Because the radiolanthanides are typically administered by injection or transfusion, the radiolanthanide sample should have a relatively low volume, and should be sufficiently dilute to allow for further incorporation of compounds to produce a biocompatible therapeutic composition that includes the radiolanthanides in the sample. Radiolanthanides are typically produced using one of three methods: a direct neutron activation method, an indirect neutron activation method, and a fission method.

Direct neutron activation produces radiolanthanides by exposing an enriched parent isotope sample to high-energy neutrons. For example, ¹⁷⁷Lu may be produced by direct neutron activation of enriched ¹⁷⁶Lu. Although direct neutron activation produces a relatively high yield of radiolanthanides, the resulting sample contains not only the radiolanthanide, but also the excess parent lanthanide and long-lived radiolanthanide impurities. For the production of ¹⁷⁷Lu by direct neutron activation, about 20%-30% of the ¹⁷⁶Lu in the original sample may be converted to ¹⁷⁷Lu, and the remainder of the sample includes impurities such as ¹⁷⁶Lu as well as ^{177m}Lu, a long-lived metastable radiolanthanide impurity. Because the Lu isotopes in the resulting example are nearly identical chemically, it is virtually impossible to separate the desired ¹⁷⁷Lu radiolanthanide from the other Lu isotope contaminants in the sample. Further, therapeutic compositions produced using direct neutron activation deliver the impurities along with the desired radiolanthanide, since the desired radioisotope and associated impurities have an equal affinity for binding to any guiding systems included in the therapeutic composition, adversely affecting the efficacy of the therapeutic composition.

Indirect neutron activation involves neutron capture by a parent isotope, followed by beta-decay of an intermediate parent radioisotope to the desired radioisotope product. For example, ¹⁷⁷Lu radioisotope product may be produced by neutron activation of enriched ¹⁷⁶Yb parent isotope to produce the ¹⁷⁷Yb parent radioisotope, followed by beta decay of the ¹⁷⁷Yb to produce the ¹⁷⁷Lu radioisotope product. Indirect neutron activation results in a sample containing a mixture of the parent isotope, the parent radioisotope and the desired product radioisotope. Because the parent isotope and the parent radioisotope are typically a different lanthanide element from the radioisotope product, it is extremely difficult, but possible, to separate the desired radioisotope from the other contaminants in the sample.

Ongoing research has been directed to the development of various methods of separating the radiolanthanides produced by indirect neutron activation from the parent lanthanides to produce a radiolanthanide sample with high specific activity. Purification methods to date have proven to be unsuitable due to poor separation of the desired radiolanthanides from the parent lanthanide and parent radiolanthanide, the introduction of undesirable impurities from the purification reagents, the inability to recover the parent lanthanide for reuse, unacceptably high radiolanthanide sample volumes, and the inability of the methods to be conducted on a larger commercial scale.

A need in the art exists for a simplified method of separating a radiolanthanide from a sample containing the radiolanthanide as well as other impurities including the parent lanthanide and the parent radiolanthanide, yielding a relatively low volume sample having relatively high specific activity and containing the radioisotope and biocompatible carrier substances. In addition, the method should be relatively insensitive to the presence of a wide variety of sample contaminants, provide the ability to recover the parent lanthanide in a reusable form, and possess the ability to operate at either a small scale or a commercial scale.

### SUMMARY OF INVENTION

Among the various aspects of the invention, therefore, is the provision of a method of separating a lanthanide from a mixture that includes the lanthanide and at least one other lanthanide. The method includes loading the mixture into a HPLC chromatography column that includes a metal-free cationic exchange media and introducing a mobile phase into the HPLC chromatography column. The mobile phase contains an acid chosen from α-HIBA, citrate, α-H-α-HIBA, lactic acid, and combinations thereof. The method also includes collecting an eluate that contains the lanthanide from the HPLC chromatography column.

Another aspect of the invention encompasses a method of producing a radiolanthanide composition having a volume of less than about 1 ml. The method includes comprising separating a radiolanthanide from a mixture of the radiolanthanide and at least one other lanthanide by loading the mixture into a HPLC chromatography column that contains a metal-free cationic exchange media. The method also includes introducing a mobile phase into the HPLC chromatography column. The mobile phase contains an acid selected from α-HIBA, citrate, α-H-α-HIBA, lactic acid, and combinations thereof. The method further includes collecting an eluate that contains the radiolanthanide and the mobile phase from the HPLC chromatography column and loading the eluate into a second chromatography column that includes an extraction chromatographic material. Additionally, the method includes introducing a second mobile phase into the second chromatography column. The second mobile phase includes a dilute acid selected from HCl, HNO₃, boric acid, and combinations thereof. In addition, the method includes collecting the radiolanthanide composition as it elutes from the second chromatography column.

A further aspect of the invention provides a method of separating a lanthanide from a mixture that contains the lanthanide and at least one other lanthanide. The method includes loading the mixture into a HPLC chromatography column that includes a metal-free cationic exchange media, and introducing a mobile phase into the HPLC chromatography column. The mobile phase contains α-HIBA having a concentration ranging from about 0.1 M to about 0.25 M and the pH of the mobile phase ranges from about 3 to about 5. The method further includes collecting an eluate that contains the lanthanide and the α-HIBA from the HPLC chromatography column.

Other aspects and iterations of the embodiments are described in detail below.

### DESCRIPTION OF FIGURES

The following figures illustrate various aspects of the embodiments:

FIG. 1 is a graph showing an exemplary separation of ¹⁷⁷Lu from a mixture of ¹⁷⁷Lu, ¹⁷⁵Yb, ¹⁷⁶Yb, and ¹⁷⁷Yb.

FIG. 2 is a graph showing an exemplary separation of ¹⁶⁶Ho from a mixture of ¹⁶⁶Ho, ¹⁶⁴Dy, and ¹⁶⁶Dy.

FIG. 3 is a graph showing an exemplary separation of ¹⁶¹Tb from a mixture of ¹⁶¹Tb, ¹⁶⁰Gd, and ¹⁵⁹Gd.

FIG. 4 is a graph showing an exemplary separation of ¹⁷⁷Lu from ¹⁵³Sm using a mobile phase that included 0.3 M α-H-α-MBA at a pH of 3.12.

FIG. 5 is a graph showing an exemplary separation of ¹⁷⁷Lu from ¹⁵³Sm using a mobile phase that included 0.3 M α-H-α-MBA at a pH of 4.6.

FIG. 6 is a graph showing an exemplary separation of ¹⁷⁷Lu from ¹⁵³Sm using a mobile phase that included 0.3 M α-H-α-MBA at a pH of 3.82.

FIG. 7 is a graph showing an exemplary separation of ¹⁴⁹Pm using a mobile phase that included 0.3 M α-H-α-MBA at a pH of 4.00.

FIG. 8 is a graph showing an exemplary separation of Ho and Dy using AG 50WX8 50-100 mesh cation exchange resin and 25% water/75% HIBA as the mobile phase.

FIG. 9 is a graph showing an exemplary separation of Ho and Dy using 50WX12 200-400 mesh cation exchange resin and 100% 0.2 M HIBA as the mobile phase starting at 100 minutes.

FIG. 10 is a graph showing a second exemplary separation of Ho and Dy using 50WX12 200-400 mesh cation exchange resin and 34% water/66% HIBA as the mobile phase.

### DETAILED DESCRIPTION

### I. Overview of Method

Embodiments of the invention provide methods of separating a lanthanide from a mixture that includes the lanthanide and at least one other lanthanide. In an embodiment, the lanthanide may be a radiolanthanide produced using the indirect method described above, and the other lanthanides may include the parent lanthanide and parent radiolanthanide of the radiolanthanide in the mixture. Further, the mixture may contain a dilute acid including but not limited to 0.05 M HCl to enhance the solubility of the lanthanides in the mixture.

Because the radiolanthanides and lanthanides in the mixture are nearly identical chemically, the separation of radiolanthanide is an extremely challenging purification process. In various embodiments described in detail below, this difficult separation of the chemically similar lanthanide isotopes is achieved using HPLC and liquid chromatographic separation techniques.

In one exemplary embodiment, the method includes loading the mixture that includes the radiolanthanide, parent lanthanide, and parent radiolanthanide into a HPLC chromatography column that includes a metal-free cationic exchange media as a stationary phase in the column. The stationary phase in the column has a relatively high affinity for lanthanides in the presence of a dilute acid such as the 0.05 M HCl that is typically included in the mixture. In this embodiment, the method also includes introducing a mobile phase that includes an acid such as α-HIBA into the HPLC chromatography column.

Without being bound to any particular theory, the mobile phase interferes slightly with the cation-exchange interactions responsible for the retention of the lanthanides of the stationary phase. In the presence of the mobile phase, the retention times of the various lanthanides in the mixture are slightly influenced by the physical size of each particular lanthanide, with the smallest lanthanides in the mixture eluting first out of the HPLC chromatography column. Because the physical size of the lanthanide atoms decreases with increasing atomic number, the radiolanthanides, which typically have the highest atomic number of the lanthanides in the mixture, will elute first, followed by the parent lanthanide and parent radiolanthanide from the indirect radiolanthanide production method.

In an embodiment, any of the other lanthanides may be captured as the lanthanides elute from the HPLC chromatography column in addition to the radiolanthanide. In this embodiment a mixture containing two or more radiolanthanides may be separated, or the parent lanthanide and or parent radiolanthanide may be captured and recycled through another indirect radiolanthanide production method

In another embodiment, the eluate from the HPLC chromatography column that includes the radiolanthanide may undergo a second chromatographic separation to separate the radiolanthanide from the acid in the mobile phase. This same embodiment includes loading the eluate from the HPLC chromatography column into a second chromatography column that includes an extraction chromatographic material. In an embodiment, a strong acid including but not limited to nitric acid having a concentration ranging from about 1N to about 8 N may be added to the eluate in order to adjust the pH of the eluate prior to loading the eluate into the second chromatography column. The extraction chromatographic material has a high affinity for lanthanides in the eluate or pH-adjusted eluate, and a lower affinity for the lanthanides in the presence of a second mobile phase that includes a dilute acid. This embodiment further includes introducing a second mobile phase that includes a dilute acid into the second chromatography column. Without being bound to any particular theory, the second mobile phase interferes with the interactions between the radiolanthanides and the extraction chromatographic material, causing the radiolanthanides to elute from the second chromatography column within a relatively small volume of second mobile phase. In one exemplary embodiment, the volume of the second eluate containing the radiolanthanide dissolved in the second mobile phase has a volume of less than about 1 ml. The second eluate containing the radiolanthanide may be used in the production of a therapeutic composition that includes radiolanthanides.

The separation of various lanthanides from mixtures containing two or more different lanthanides and/or radiolanthanides has at least several different applications, depending on the particular mixture to be separated, and the desired lanthanide end products. In one non-limiting example, an embodiment may be used to separate a radiolanthanide produced by the indirect method from a mixture that includes the desired radiolanthanide, the parent lanthanide, and the parent radiolanthanide, as well as reclaiming the parent lanthanide and radiolanthanides for reuse in the production of additional radiolanthanide using the indirect method. In another non-limiting example, radiolanthanides and lanthanides may be separated from a mixture of fission products that may further include other radioactive and non-radioactive metal by-products. In yet another non-limiting example, lab or industrial waste may be processed using an embodiment in order to obtain a desired lanthanide for radiolanthanide production, a radiolanthanide for use in an application such as a therapeutic composition, or to eliminate the radiolanthanides from the remaining waste, potentially simplifying the storage and disposal of the remaining waste if the remaining waste includes only non-radioactive elements.

A more detailed description of various aspects of the embodiments is presented below.

### II. Lanthanide and Radiolanthanide Mixtures

The mixtures from which lanthanides are separated using embodiments of the HPLC and liquid chromatographic separation methods generally include any isotope or radioisotope of an element including but not limited to La, Ce, Pr, Nd, Pm, Sm, Eu, Gd, Tb, Dy, Ho, Er, Tm, Yb, or Lu. The lanthanides are typically dissolved in a dilute acid that may be any acid capable of maintaining the lanthanides dissolved within the mixture and/or keeping the mixture at a sufficiently low pH so as to prevent the hydrolysis of the lanthanides. Non-limiting examples of acids suitable for use as dilute acids in the mixture include HCl, HNO₃, boric acid, and combinations thereof.

The concentration of the dilute acid depends on at least several factors including but not limited to the particular dilute acid, the particular lanthanide dissolved in the weak acid, and the particular stationary phase composition in the HPLC chromatography column. In an embodiment, the concentration of the dilute acid may range from about 0.01N to about 0.25 N. In other embodiments, the concentration may range from about 0.01N to about 0.05 N, from about 0.04 N to about 0.1N, from about 0.07 N to about 0.15 N, from about 0.15 N to about 0.2 N, and from about 0.19 N to about 0.24 N, and from about 0.2 N to about 0.25 N. In an exemplary embodiment, the acid is 0.05 N HCl.

In addition to the lanthanide and dilute acid, the mixture further contains at least one other lanthanide in an embodiment. In this embodiment, the other lanthanides in the mixture are a different lanthanide element than the lanthanide previously described above. In this embodiment, each other lanthanide is selected from any isotope or radioisotope of an element including but not limited to La, Ce, Pr, Nd, Pm, Sm, Eu, Gd, Tb, Dy, Ho, Er, Tm, Yb, or Lu. In one embodiment, the one or more other lanthanides may include the parent lanthanide and the parent radiolanthanide from the indirect production process used to produce the radiolanthanide. In another embodiment, the other lanthanides may be lanthanides and/or radiolanthanides resulting from a fission process. In an exemplary embodiment, the mixture includes ¹⁷⁷Lu as the lanthanide, ¹⁷⁶Yb and ¹⁷⁷Yb as the other lanthanides, and 0.05 N HCl.

The mixture of various embodiments may come from a variety of sources including but not limited to indirect production of one or more radiolanthanides, production of two or more radiolanthanides using direct neutron absorption methods, nuclear fission by-products, and laboratory waste products. In an embodiment, the mixture may additionally include other contaminants including but not limited to lead and zinc.

### III. Chromatography Columns

In various embodiments, HPLC and liquid chromatography columns are used to implement the embodiments of the HPLC and liquid chromatography separation methods. In a first embodiment, a HPLC chromatography column is used to separate a lanthanide from a mixture including the lanthanide and at least one other lanthanide. In a second embodiment, a second chromatography column is used to separate the lanthanide from the mobile phase eluted from the HPLC chromatography column in the first embodiment. Detailed descriptions of the HPLC chromatography column and the second chromatography column are given below.

### A. HPLC Chromatography Column

In various embodiments, the lanthanide is separated from the mixture using separation chromatography methods with a HPLC chromatography column. The composition of the stationary phase included in the HPLC chromatography column is a critical element of the separation method. Because the lanthanide and the other lanthanides are virtually identical chemically, the composition of the stationary phase is a determining factor in the differential retention of the lanthanides on the HPLC chromatography column. Without being bound to any particular theory, the differential retention of the lanthanides on the HPLC chromatography column are driven by atomic sized-based interactions on a background of cation-exchange interactions.

Any suitable chromatography stationary phase media may be included in the HPLC chromatography column, so long as the stationary phase media has a higher affinity for the lanthanides in presence of the dilute acid relative to the affinity for the lanthanides in the presence of the mobile phase. In an exemplary embodiment, the stationary phase is a metal-free cationic exchange media having no residual metal content. Suitable stationary phase media for the HPLC chromatography column are well-known in the art and commercially available. Non-limiting examples of suitable stationary phase media include: Ionpac CS-3 column media (Dionex Corp., Sunnyvale, Calif., USA); LN resin (Eichrom Industries, Inc., Darien, Ill., USA); and RE resin (Eichrom Industries, Inc., Darien, Ill., USA).

Because the HPLC and liquid chromatographic separation methods of the various embodiments are relatively insensitive to the physical dimensions of the HPLC chromatography column, any size of HPLC chromatography column may be used so long as it includes stationary phase media having the characteristics described above. Non-limiting examples of suitable HPLC chromatography column sizes include 4 mm×250 mm, and 9 mm×250 mm. In another embodiment, larger column sizes may be used without limitation. An exemplary embodiment includes the Ionpac CS-3 column media (Dionex Corp., Sunnyvale, Calif., USA) having dimensions of 4 mm×250 mm.

### B. Second Chromatography Column

In an embodiment, the desired lanthanide is separated from the eluate emerging from the HPLC chromatography column described above. The eluate includes the lanthanide and the mobile phase, which may be unsuitably acidic for use in medical applications, and may have an undesirably large volume. Therefore, the second chromatography column is selected to possess the capability of removing the lanthanide from the mobile phase under relatively acidic conditions, and to elute the lanthanide using a relatively low volume of a second mobile phase having relatively weak acidity.

Any suitable chromatography stationary phase media may be included in the second chromatography column, so long as the stationary phase media has a higher affinity for the lanthanides in presence of the acidic mobile phase relative to the affinity for the lanthanides in the presence of the weakly acidic second mobile phase. In an exemplary embodiment, the stationary phase for the second chromatography column is a rare earth resin. Non-limiting examples of suitable stationary phase media for the second chromatography column are commercially available and include LN resin (Eichrom Industries, Inc., Darien, Ill., USA); and RE resin (Eichrom Industries, Inc., Darien, Ill., USA). In other embodiments, depending on the particular lanthanide to be separated from the mobile phase, the second chromatography column may additionally include an amount of prefilter resin (Eichrom Industries, Inc., Darien, Ill., USA) in a ratio of about 1:1 (prefilter resin volume: LN or RE resin volume).

Any size of second chromatography column may be used so long as it includes stationary phase media having the characteristics described above. However, a smaller second column results in a lower volume of second eluate, if this is desired. A non-limiting example of a second chromatography column is a hand-packed column having a volume of at least 0.5 ml.

An exemplary embodiment of a second chromatography column includes about 0.8 mL of RN resin loaded on top of 0.8 mL of prefilter resin (Eichrom Industries, Inc., Darien, Ill., USA). In another exemplary embodiment, the eluate is run through an additional chromatography column including LN resin prior to loading into a second chromatography column containing 0.8 mL of RN resin loaded on top of 0.8 mL of prefilter resin.

### IV. Mobile Phases

In various embodiments, the lanthanide is eluted from the HPLC chromatography column using a mobile phase, and from the second chromatography column using a second mobile phase. The mobile phase and second mobile phase are described in detail below.

### A. Mobile Phase

In an embodiment, the lanthanide is eluted from the HPLC chromatography column separately from the other lanthanides in the mixture by introducing a mobile phase into the HPLC chromatography column. The composition of the mobile phase introduced into the HPLC chromatography column is another critical element of the separation method. Without being bound to any particular theory, the chemically reactive moieties contained within the mobile phase interfere with the interactions between the lanthanide and the at least one lanthanide such that the compounds emerge from the HPLC chromatography column with different retention times due to atomic size-related interactions with the stationary media.

In various embodiments, the mobile phase includes an acid, which in turn influences the pH of the mobile phase. Non-limiting examples of suitable acids for the mobile phase include α-HIBA, citrate, α-H-α-HIBA, α-H-α-MBA, lactic acid, and combinations thereof. The particular acid included in the mobile phase is selected based on at least several factors including but not limited to the composition of the stationary phase in the HPLC column, and the particular lanthanide elements in the mixture to be separated. In an embodiment, the concentration of the acid in the mobile phase may range from about 0.1N to about 0.3 N.

In other embodiments, the concentration of the acid in the mobile phase may range from about 0.1N to about 0.15 N, from about 0.12 N to about 0.18 N, from about 0.15 N to about 0.2 N, from about 0.18 N to about 0.23 N, from about 0.2 N to about 0.25 N, from about 0.23 N to about 0.28 N, and from about 0.25 N to about 0.3 N. The concentration of the acid included in the mobile phase is selected based on at least several factors including but not limited to the composition of the stationary phase in the HPLC column, the particular lanthanide elements in the mixture to be separated, and the particular acid selected for the mobile phase.

In another embodiment, the mobile phase may be introduced into the HPLC chromatography column at a constant composition. In another additional embodiment, the mobile phase may be introduced into the HPLC chromatography column in a gradient, in which the composition of the mobile phase changes with respect to time.

The pH of the mobile phase introduced into the HPLC chromatography column is dependent upon the particular acid and concentration of acid included in the mobile phase. In an embodiment, the pH of the mobile phase ranges from about 2 to about 6. In other embodiments, the pH of the mobile phase ranges from about 2 to about 2.5, from about 2.3 to about 2.7, from about 2.5 to about 3, from about 2.7 to about 3.3, from about 3 to about 3.5, from about 3.2 to about 3.7, from about 3.5 to about 4, from about 3.7 to about 4.3, from about 4 to about 4.5, from about 4.3 to about 4.7, from about 4.5 to about 5, from about 4.7 to about 5.3, from about 5 to about 5.5, from about 5.3 to about 5.8, and from about 5.5 to about 6. In an embodiment, the particular pH of the mobile phase is selected to optimize the elution of the lanthanide from the HPLC chromatography column.

In an exemplary embodiment, if the mixture includes ¹⁷⁷Lu, ¹⁷⁶Yb, and ¹⁷⁷Yb, the mobile phase includes 0.15 N α-HIBA at a pH of about 3.12. Other exemplary embodiments of the mobile phase are described in the examples below.

### B. Second Mobile Phase

In an embodiment, the lanthanide is eluted from the second chromatography column by introducing a second mobile phase into the second chromatography column. The composition of the second mobile phase is selected based on at least several factors.

In one embodiment, the composition of the second mobile phase is selected in order to implement the release of the lanthanide from the second chromatography column using a relatively low volume of second mobile phase, including but not limited to less than about 1 mL. In another embodiment, the composition of the second mobile phase is selected such that the lanthanide remains dissolved in the second eluate. In yet another embodiment, the composition of the second mobile phase is selected to be sufficiently dilute to allow for further incorporations of compounds to produce a biocompatible therapeutic composition. Biocompatible, as defined herein, refers to a property of a composition in which the composition does not cause an adverse reaction when injected, transfused, or otherwise administered to an organism including but not limited to mammals. Non-limiting examples of adverse reactions include allergic reactions, inflammatory reactions, and significant alteration of any normal biological function including but not limited to cell respiration, cell reproduction, and cell growth.

### V. Eluates

In various embodiments, an eluate emerges from the HPLC chromatography column and a second eluate emerges from the second chromatography column. The compositions of the eluate and the second eluate are discussed in detail below.

### A. Eluate

In an embodiment, the eluate emerges from the HPLC chromatography column that includes the lanthanide dissolved in the mobile phase. The composition of the eluate depends on at least a variety of factors described above for the selection of a particular mobile phase as well as the lanthanide to be separated from the mixture. In an embodiment, the volume of the eluate depends on a variety of factors including but not limited to the size of the HPLC chromatography column, the flow rate of the mobile phase through the HPLC chromatography column, and the retention time of the lanthanide on the HPLC chromatography column. In an exemplary embodiment, if the column size is about 4 mm×250 ml and the flow rate is about 1 ml/minute, the volume of the eluate may range from about 1 ml to about 20 ml.

If the mixture to be separated contains two or more isotopes of the same lanthanide element, the eluate may include two or more isotopes of the same lanthanide element in an embodiment. Because the HPLC chromatography column is not capable of differentiating between different isotopes of the same lanthanide element, typically all isotopes of the same lanthanide element elute in a similar time frame from the second chromatography column. In another embodiment, the eluate may include two or more isotopes of the same lanthanide element.

In another embodiment, a third eluate emerges from the HPLC chromatography column that includes one or more of the other lanthanides dissolved in the mobile phase. In a manner similar to the composition of the eluate, the composition of the third eluate depends on at least a variety of factors described above for the selection of a particular mobile phase. In an embodiment, the volume of the eluate depends on a variety of factors including but not limited to the size of the HPLC chromatography column, the flow rate of the mobile phase through the HPLC chromatography column, and the retention time of the lanthanide on the HPLC chromatography column. In an exemplary embodiment, if the column size is about 4 mm×250 ml and the flow rate is about 1 ml/minute, the volume of the third eluate may range from about 1 ml to about 20 ml.

In another exemplary embodiment, if the mixture to be separated includes a radiolanthanide produced using an indirect method, and the mixture further includes the parent lanthanide and the parent radiolanthanide, in which both the parent lanthanide and the parent radiolanthanide are isotopes of the same element, the third eluate includes the parent lanthanide and the parent radiolanthanide due to the lanthanide discriminative properties of the HPLC chromatography column described above.

### B. Second Eluate

In an embodiment, a second eluate emerges from the second chromatography column that includes the lanthanide dissolved in the second mobile phase. The composition of the second eluate depends on at least a variety of factors described above for the selection of a particular second mobile phase as well as the lanthanide to be separated from the mobile phase. In an embodiment, the volume of the second eluate depends on a variety of factors including but not limited to the size of the second chromatography column, the flow rate of the second mobile phase through the second chromatography column, and the retention time of the lanthanide on the second chromatography column. In an exemplary embodiment, if the column size is about 0.8 ml and the flow rate is about 1 ml/minute, the volume of the eluate is less than 1 ml.

### VI. Alternative Applications

The HPLC and liquid chromatographic separation methods of various embodiments may be applied in a variety of different contexts. As described above, one embodiment may be used to separate a radiolanthanide produced using an indirect production method from the parent lanthanide and the parent radiolanthanide. An alternative embodiment may be used to separate one or more lanthanides or radiolanthanides from the products of a fission reaction. Yet another alternative embodiment may be used to reclaim one or more lanthanides from lab or industrial waste. In this embodiment, the removal of the lanthanides may detoxify the lab or industrial waste, simplifying the disposal procedures for the waste. Still another alternative embodiment may be used to purify a lanthanide target prior to subjecting the lanthanide target to one of the radiolanthanide production techniques.

### EXAMPLES

The following examples illustrate aspects of the various embodiments.

### Example 1

### Separation of ¹⁷⁷Lu from ¹⁷⁶Yb/¹⁷⁷Yb

To assess the sensitivity of a HPLC and liquid chromatographic separation method to variations in process parameters, and to optimize those process parameters, the following experiment was conducted. ¹⁷⁶Yb was subjected to an indirect radiolanthanide production method, resulting in a mixture of ¹⁷⁶Yb parent lanthanide, ¹⁷⁷Yb parent radiolanthanide, and ¹⁷⁷Lu radiolanthanide. The mixture was dissolved in 0.05 N HCl to form a solution.

The ¹⁷⁷Lu radiolanthanide was separated from the mixture using a HPLC and liquid chromatographic separation method. Separations were carried out on a Waters metal free HPLC system connected to a sodium iodide detector system, equipped with a Dionex Ionpac CS-3 (4×250 mm) cation column, sodium form. The CS-3 cation exchange column was made up of a polystyrene/divinyl benzene support and was placed in-line following the CG-3 guard column. Typically about 5 to 45 μL of the mixture samples were loaded into the HPLC cation exchange columns at a flow rate of around 1 mL/min.

Reagent grade α-HIBA was used to prepare the mobile phase. Measurements of mobile phase pH were performed on an Accument XL 15 pH meter standardized using NIST traceable solutions at pH values of 2.00, 4.00 and 7.00. A series of different combinations of eluent pH (ranging from abut 3.0 to about 5.0) and α-HIBA concentration (ranging from abut 100 mM to about 250 mM) were carried out to determine the optimal conditions for HPLC separation.

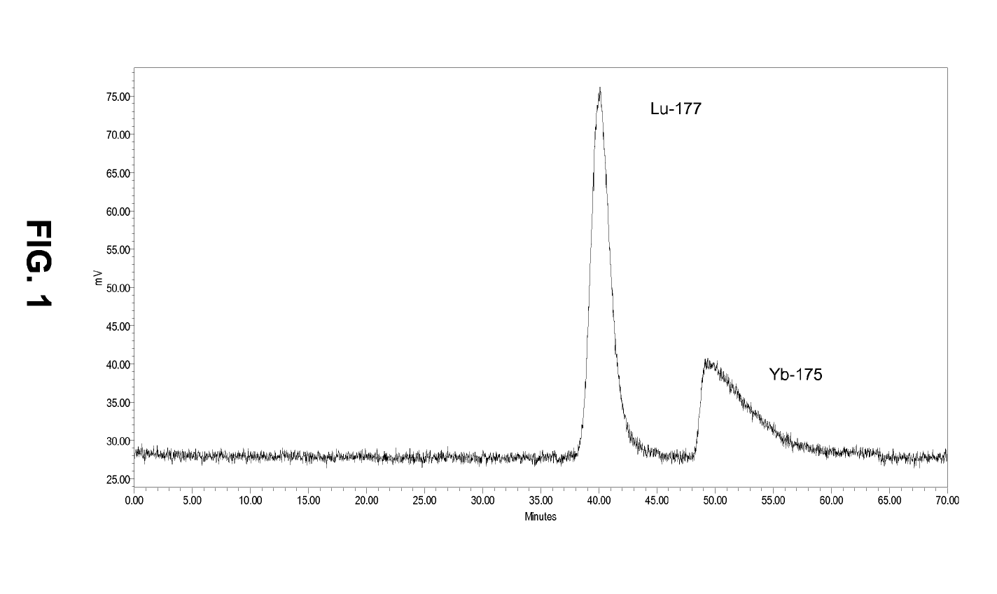

Retention time of the lanthanides increased with decreasing pH and α-HIBA concentration. FIG. 1 summarizes the elution concentrations measured during an optimized HPLC separation. As shown in FIG. 1, the peak with retention time at around 40 min is the ¹⁷⁷Lu fraction, while the peak with retention time at around 50 min is the Yb fraction. Since the ¹⁷⁷Lu elutes from the column first, it was possible to produce essentially 100% pure isotope by collecting the fraction(s) prior to the elution of the Yb peak.

Using the results of this experiment, the HPLC separation method was optimized for retention time and purity. The optimized HPLC separation conditions with the above mentioned Dionex CS-3 column (it should be noted that other strong cationic exchange columns have been evaluated and shown to work) for ¹⁷⁷Lu were determined to be about 0.15 M α-HIBA at a pH of about 3.12 at room temperature and a flow rate of about 1 mL/min.

To remove the separated radiolanthanide from the α-HIBA in the eluate, a second separation was conducted. Although a variety of options for separation exist at the current time, the extraction/concentration was performed using liquid chromatographic separation methods.

A chromatography column was packed with a combination of 0.8 mL of RE resin (Eichrom Industries, Inc., Darien, Ill., USA) and 0.8 mL of pre-filter resin (Eichrom Industries, Inc., Darien, Ill., USA). The ¹⁷⁷Lu radiolanthanide eluate was loaded onto the column in about 1 to about 8 M HNO₃. The acid concentration used to load the RE column may vary depending on the specific lanthanide. The RE column was then rinsed with about 3 to 5 mL of nitric acid and the ¹⁷⁷Lu was eluted using a 0.05 M HCl mobile phase.

### Example 2

### Separation of ¹⁶⁶Ho from Dy Parent Lanthanide

To assess the effectiveness of the HPLC and liquid chromatographic separation method on radiolanthanides other than ¹⁷⁷Lu, the following experiment was conducted. The HPLC and liquid chromatographic separation conditions described in Example 1 were modified to perform the separation of ¹⁶⁶Ho from its parent lanthanide Dy.

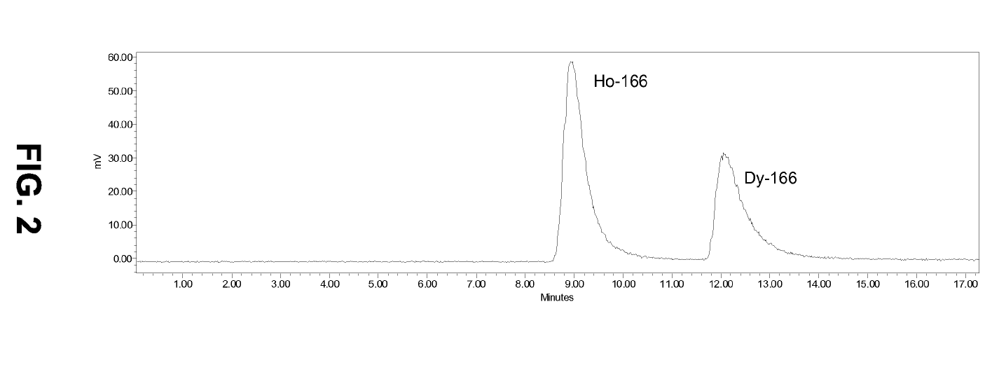

The best separation was achieved with an isocratic method using about 0.18 M α-HIBA at a pH of about 3.5 and a flow rate of about 1 mL/min. FIG. 2 summarizes the elution of the ¹⁶⁶Ho and the Dy in separate peaks after being loaded into the HPLC column. The retention time of ¹⁶⁶Ho was about 9 min and the retention time of around 12-13 min was the Dy fraction. The results of this experiment demonstrated that other lanthanides besides ¹⁷⁷Lu may be separated with essentially 100% purity using the HPLC and liquid chromatographic separation method.

### Example 3

### Separation of ¹⁶¹Tb from Gd Parent Lanthanide

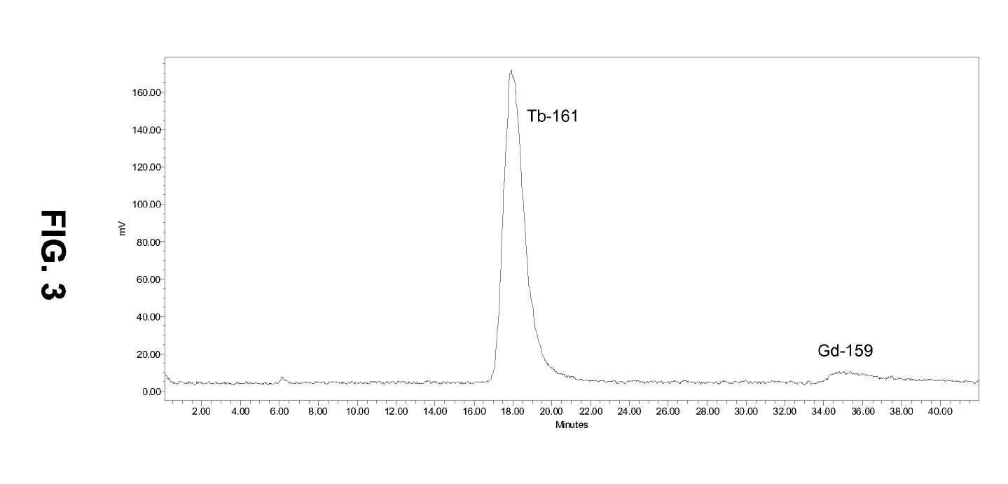

To assess the effectiveness of the HPLC separation method on ¹⁶¹Tb, the following experiment was conducted. The HPLC separation conditions described in Example 1 were modified to perform the separation of ¹⁶¹Tb from its parent lanthanide Gd. FIG. 3 summarizes the elution of ¹⁶¹Tb and Gd during the HPLC separation.

The results of this experiment demonstrated that ¹⁶¹Tb may be separated with essentially 100% purity using the HPLC and liquid chromatographic separation method.

### Example 4

### Comparison of Purity of ¹⁷⁷Lu from Direct Production and ¹⁷⁷Lu from Indirect Production/HPLC and Liquid Chromatographic Separation

To compare the purity of ¹⁷⁷Lu produced using a direct production method and ¹⁷⁷Lu produced using a direct production method and separated using the HPLC and liquid chromatographic separation method described in Example 1, the following experiment was conducted.

ICP-OES was used to evaluate and compare two samples of ¹⁷⁷Lu, one produced using a direct production method and one produced using an indirect production method. The evaluations included analyzing the recovered target material and the isolated carrier free radionuclide as well as the presence of unwanted metal impurities in each sample. Samples were diluted in 2% hydrochloric acid and supplemented with a known level of yttrium as an internal standard. A calibration curve was constructed with standards of known concentrations that also contained the internal standard.

Samples and standards were introduced into the instrument using a nebulizer to produce a fine spray. The net intensity of the particular wavelength selected for each element was compared to the linear regression line of the standards after subtracting the amount of the element measured in the diluent blank and correcting for the difference in intensity using the internal standard as a reference.

The results of the ICP-OES measurements for the two ¹⁷⁷Lu samples are compared in Table 1. The ¹⁷⁷Lu produced by direct production methods had significantly higher levels of all metal contaminants tested.

TABLE 1
Purity of Lu Samples Produced by Direct
Production and Indirect Production.

| Contaminating | Direct Product | Indirect Product |
|---|---|---|
| Elements | Lu Sample (ppb) | Lu Sample (ppb) |
| Lu | 105611 | not detected |
| Hf | 46423 | not detected |
| Al | 3586 | 105 |
| Ca | 5467 | 90 |
| Zn | 6217 | 198 |

The results of the this experiment demonstrated the indirect production of ¹⁷⁷Lu followed by HPLC and liquid chromatographic separation of ¹⁷⁷Lu yielded a sample with much higher purity than the ¹⁷⁷Lu produced by direct production methods.

### Example 5

### Purity of ¹⁷⁷Lu from Indirect Production/HPLC and Liquid Chromatographic Separation Compared to Other ¹⁷⁷Lu Separation Methods

To compare the purity of ¹⁷⁷Lu produced using an indirect production method and HPLC and liquid chromatographic separation to ¹⁷⁷Lu produced using an indirect production method and other separation methods, the following experiment was conducted.

A sample of ¹⁷⁷Lu produced using a indirect production method and HPLC and liquid chromatographic separation was subjected to ICP-OES measurements similar to those described in Example 4 and compared to similar measurements of ¹⁷⁷Lu separated using two other separation methods. In one of the other samples, the ¹⁷⁷Lu produced using a indirect production method was stirred with 5% Na amalgam beads (Sigma Aldrich, St. Louis, Mo., USA). In another sample, the indirectly produced ¹⁷⁷Lu was stirred with controlled pore glass beads (Sigma Aldrich, St. Louis, Mo., USA) loaded with the Na amalgam. The results of the ICP-OES are summarized in Table 2. With the exception of Mg, the HPLC and liquid chromatographic separation method removed significantly higher amounts of the metal impurities than either of the other separation methods.

TABLE 2
Purity of Indirectly Produced Lu Samples
Separated Using Three Separation Methods.

| | HPLC | Amalgam | Amalgam-loaded |
|---|---|---|---|
| Contaminating | Separation | Separation | Glass Bead |
| Elements | (ppb) | (ppb) | Separation (ppb) |
| Al | 88.17 | 426.19 | 97.75 |
| Ca | 20.4 | 988.60 | 761.19 |
| Cu | 0.00 | 281.05 | 0.00 |
| Fe | 178.06 | 272.69 | 29.51 |
| Pb | 57.14 | 1165.44 | 853.49 |
| Mg | 21.53 | 55.18 | 9.11 |
| Mn | 0.00 | 123.25 | 11.61 |
| Ni | 8.09 | 125.92 | 857.95 |
| K | 122.16 | 22267.8 | 23211.10 |
| Sc | 0.00 | 0.00 | 0.00 |
| Zn | 140.51 | 1096.74 | 1470.34 |
| Hf | 0.00 | 0.00 | 0.00 |
| Lu | 0.0 | 60.53 | 13.39 |
| Yb | 0.00 | Saturated | 159077.56 |
| Hg | — | 19161.48 | 3183.38 |

The results of this experiment demonstrated that indirect production of ¹⁷⁷Lu followed by HPLC and liquid chromatographic separation of ¹⁷⁷Lu yielded a sample with much higher purity than the ¹⁷⁷Lu separated using other methods.

### Example 6

### Metal Contaminants of Different Stationary Media were Compared

To compare the metal contaminants contained within two different stationary media considered for use in the HPLC and liquid chromatographic separation method, the following experiments were conducted.

Two HPLC columns containing different stationary media compositions were prepared for comparison. The first HPLC column was prepared by loading prepared Dowex AG 50W-X4 or AG 50W-X8 cation exchange resin, NH⁴⁺ form, 24 to 45 μM (Dow Chemical Company, USA) into a 70 cm×8 mm i.d. Pyrex tube to a height of 65 cm. The Dowex resin was prepared by successive washing with 6 M HCl, 1 M NH₄CNS, 6 M HCl, 1 M NH₄OH, and H₂O.

The second column was prepared by similarly loading a similar Pyrex tube with prepared LN spec resin (Eichrom Industries, Inc., Darien, Ill., USA). The LN spec resin was prepared by equilibrating the resin in 0.15 N nitric acid.

The two columns were connected to a Varian Prostar HPLC system equipped with a Varian UV absorbance detector (Model 345) and a NaI(Tl) radioisotope detector (EG&G Ortec) and run at 3 mL/min with a pressure of 150-200 psi. Initially each column was pre-equilibrated with 0.05 M alpha-hydroxyisobutyric acid (α-HIMB) at a pH of 5.5 to rinse the stationary media.

The initial washings from each column were collected and analyzed for metal impurities using ICP-MS. The results of the ICP-MS measurements for each column are summarized in Table 2 below. Higher amounts of iron, chromium, and zinc and lead were observed in the Dowex resin compared to the LN resin. An extremely high lead level was detected in the LN resin initial washing that may be an experimental artifact. Small amounts of other metals such as nickel, copper and tin were also observed in the initial washings.

The results of this experiment demonstrated that a great deal of variability exists between the contaminant metal content of different stationary media materials. The Dowex ion exchange resin had unacceptably high levels of metal contaminants.

### Example 7

### Comparison of HPLC Separation Using Alternative Stationary Phase Composition

To compare the effectiveness of the HPLC separation method using alternative stationary phase compositions, the following experiment was conducted.

The HPLC column containing the Dowex resin produced using the methods described in Example 5 was loaded with samples containing ¹⁷⁷Lu and ¹⁷⁵Yb. Mobile phase conditions were then changed to run a gradient starting from 100% 0.15 M HIBA at a pH of 5.3 and gradually changing to 100% water. The best separation of the two lanthanides in the sample was observed with a mobile phase gradient running from a concentration of 53% 0.15 M HIBA at pH 5.3 to 63% 0.15 M HIBA over three hours with a flow rate of 0.1 mL/minute. Even so, there was still a fair amount of cross over with these conditions.

The same separation conditions were tried for a similar HPLC column loaded with ¹⁴⁹Pm and neodymium but no separation of the two was observed.

The results of this experiment demonstrated that the particular composition of the Dowex cation exchange resin was not effective at separating lanthanides using an HPLC separation method similar to that described in Experiment 1.

### Example 8

### Effect of Mobile Phase pH on HPLC Separation

To assess the effect of mobile phase pH on the effectiveness of the HPLC separation method, the following experiment was conducted. The HPLC separation method that was essentially the same as that described in Experiment 1 was used to separate ¹⁷⁷Lu from ¹⁵³Sm. The mobile phase used was a mixture of 0.3 M α-hydroxyl-α-methyl butyric acid (α-H-α-MBA) pH-adjusted to values ranging from 3.0-4.0 using NH₄OH solution, and milliQ water. The percentage concentration of the α-H-α-MBA was increased with time for each of three cases summarized in Table 3.

TABLE 3
Mobile Phase Gradient Summary

| Time | Vol % α-H-α-MBA | | |
|---|---|---|---|
| (min) | pH = 3.12 | pH = 4.6 | pH = 3.82 |
| 0.01 | 20 | 10 | 20 |
| 5.00 | 20 | 50 | 20 |
| 10.00 | 30 | 50 | 30 |
| 20.00 | 35 | 50 | 35 |
| 25.00 | 40 | 50 | 40 |
| 30.00 | 45 | 50 | 45 |
| 40.00 | 50 | 50 | 50 |
| 50.00 | 70 | 50 | 50 |
| 70.00 | | 100 | 70 |

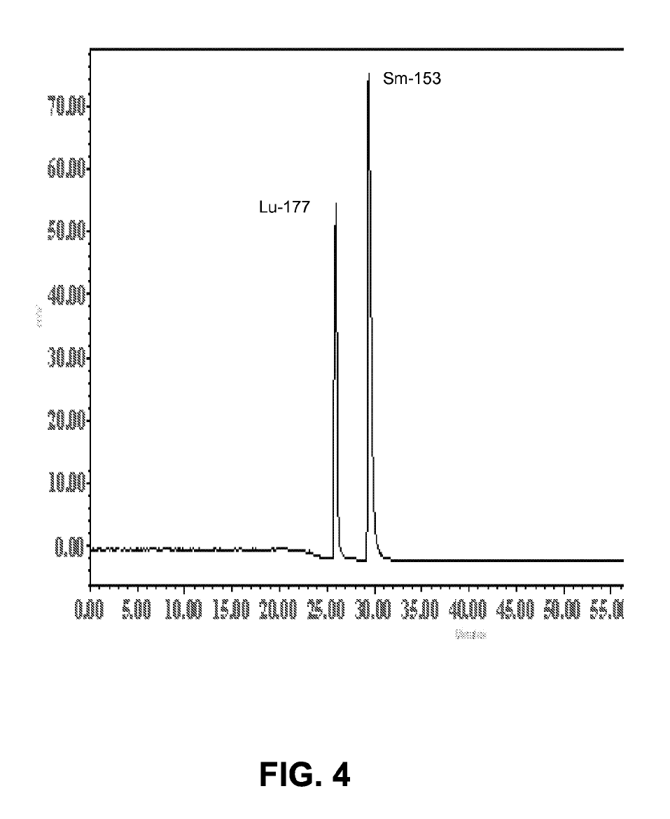

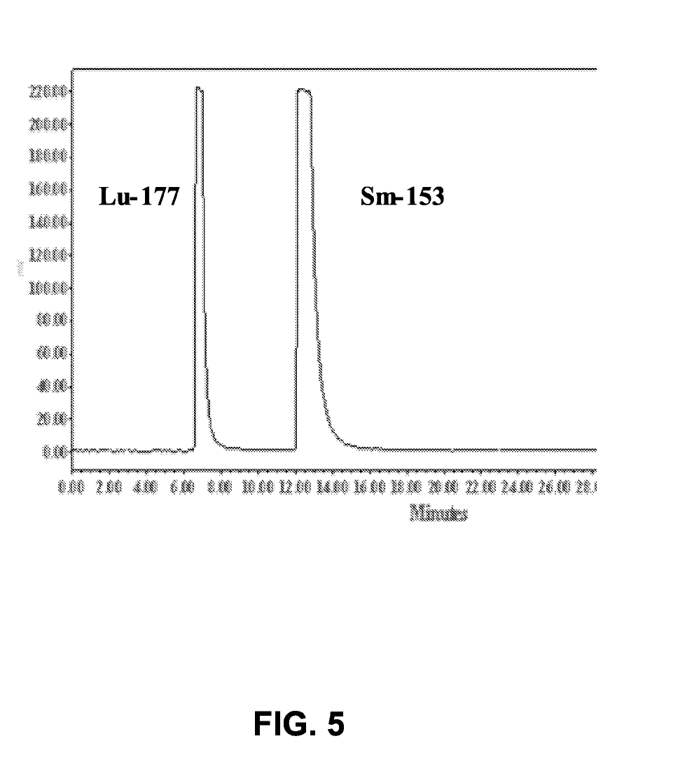

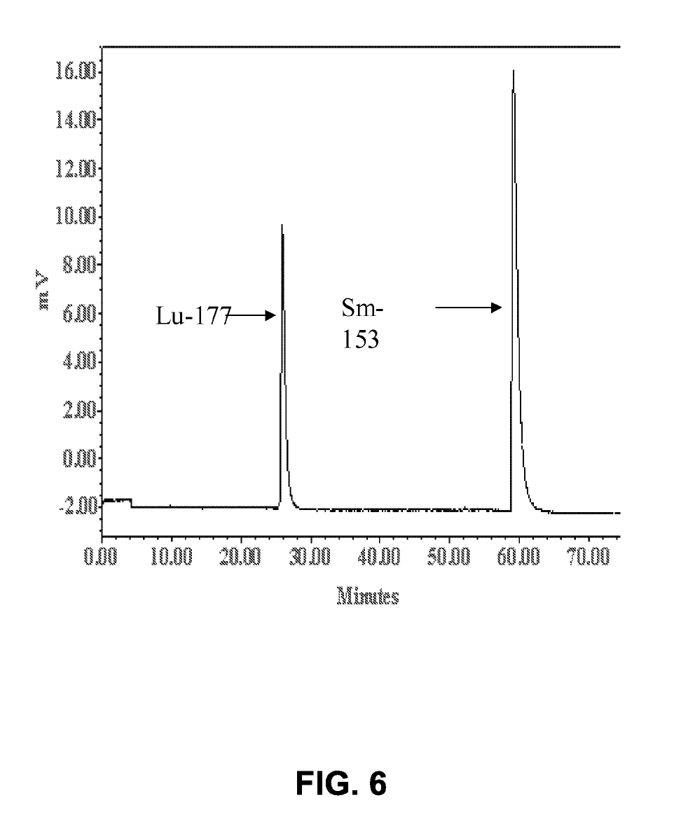

FIG. 4 is a summary of the elution of ¹⁷⁷Lu from ¹⁵³Sm using a mobile phase consisting of 0.3 M α-H-α-MBA at a pH of 3.12. FIG. 5 is a summary of the elution of ¹⁷⁷Lu from ¹⁵³Sm using a mobile phase including 0.3 M α-H-α-MBA at a pH of 4.6. FIG. 6 is a summary of the elution of ¹⁷⁷Lu from ¹⁵³Sm using a mobile phase including 0.3 M α-H-α-MBA at a pH of 3.82. The pH of the mobile phase did affect the elution of the lanthanides somewhat, but all mobile phase concentration gradients resulted in clean separations of the ¹⁷⁷Lu from the ¹⁵³Sm.

Using similar HPLC separation methods, ¹⁴⁹Pm was separated from ¹⁴⁸Nd. This separation was particularly challenging because the two lanthanides occupy adjacent positions on the periodic table and therefore possess extremely similar chemical properties. The mobile phase was a mixture of 0.3 M a-hydroxyl-a-methyl butyric acid (α-H-α-MBA) adjusted to a pH of 4.00. The mobile phase was introduced into the HPLC column using a gradient summarized in Table 4.

TABLE 4
Mobile Phase Gradient for ¹⁴⁹Pm/¹⁴⁸Nd

| SeparationTime | Mobile Phase % Volume |
|---|---|
| (min) | α-H-α-MBA |
| 0.01 | 20 |
| 5.00 | 20 |
| 8.00 | 30 |
| 10.00 | 35 |
| 15.00 | 40 |
| 20.00 | 45 |

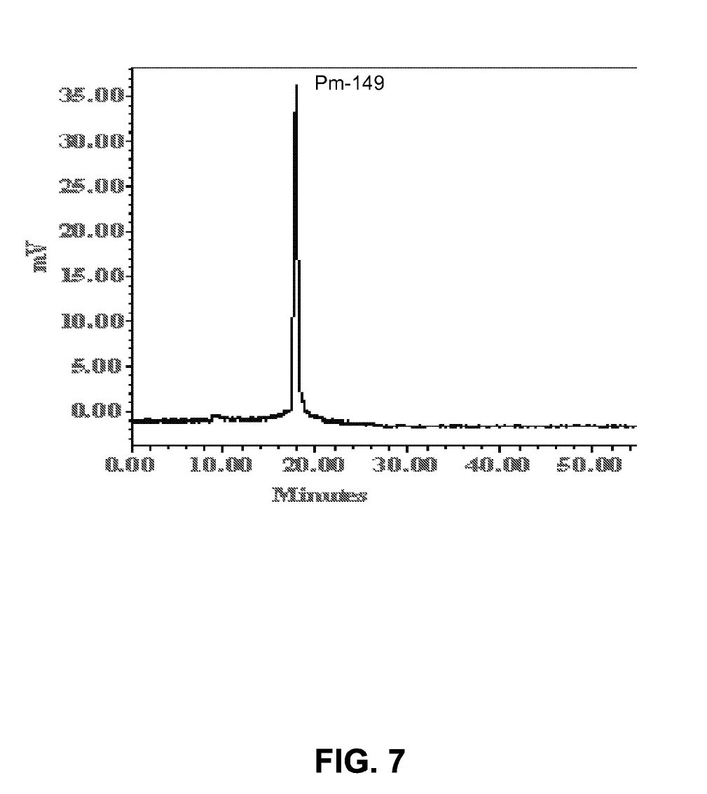

FIG. 7 is a summary of the elution of ¹⁴⁹Pm showing a distinct elution peak.

The results of this experiment demonstrated that the HPLC and liquid chromatography separation technique is effective even for lanthanides having essentially identical chemical properties.

### Example 9

### Separation of ¹⁶⁶Ho from Dy Parent Lanthanide Using AG 50WX8 Cation Exchange Resin

To assess the feasibility of performing the HPLC and liquid chromatographic separation method described in Example 1 using a different cation exchange resin composition, the following experiments were conducted.

The HPLC and liquid chromatographic separation method described in Example 1 was used to separate ¹⁶⁶Ho produced by indirect production methods from the parent Dy lanthanides. A HPLC column packed with AG 50WX8 50-100 mesh cation exchange resin (Bio-Rad) was loaded with a sample containing ¹⁶⁶Ho and Dy. A mobile phase having a composition of 57.5% water and 42.5% 0.2 M HIBA at a pH of 4.2 (0.85 M equivalent) was introduced into the HPLC column at a flow rate of 0.8 ml/min and a pressure of approximately 130 psi. After four hours during which the lanthanides had shown little movement down the column the concentration of HIBA was changed to 0.1 M equivalent but had still not released any lanthanide after 6 additional hours.

Using a HPLC column packed with the same composition of stationary phase media that had been additionally rinsed with NaOH, a mobile phase consisting of 50% water and 50% 0.2 M HIBA at a pH of 4.2 was introduced into the column, with no observable movement of the lanthanides down the HPLC column. After changing the composition of the mobile phase to 25% water and 75% 0.20 M HIBA (0.15 M equivalent) the lanthanides eluted over a period of two days, starting with the Ho and eventually eluting both Ho and Dy together.

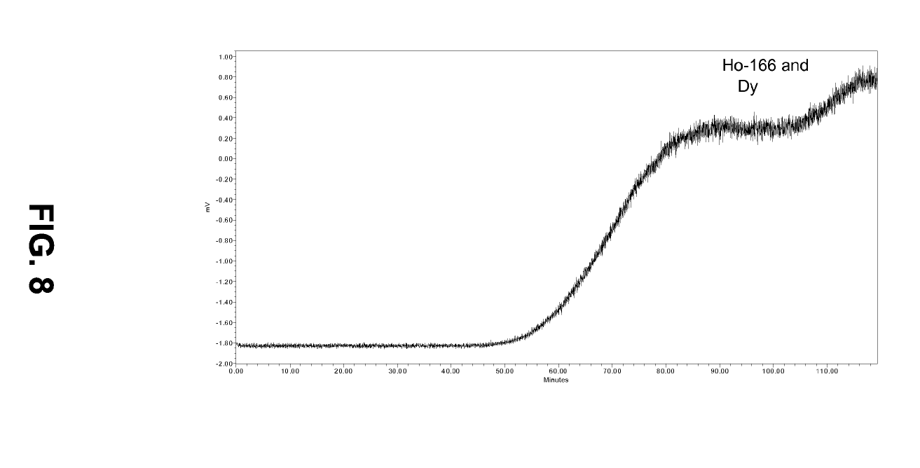

The same HPLC column composition rinsed with NaOH was loaded with Ho and Dy and a mobile phase consisting of 25% water and 75% HIBA at a pH of 4.6 was introduced into the column. FIG. 8 shows a summary of the elution in which the Ho and Dy eluted together after about 60 minutes.

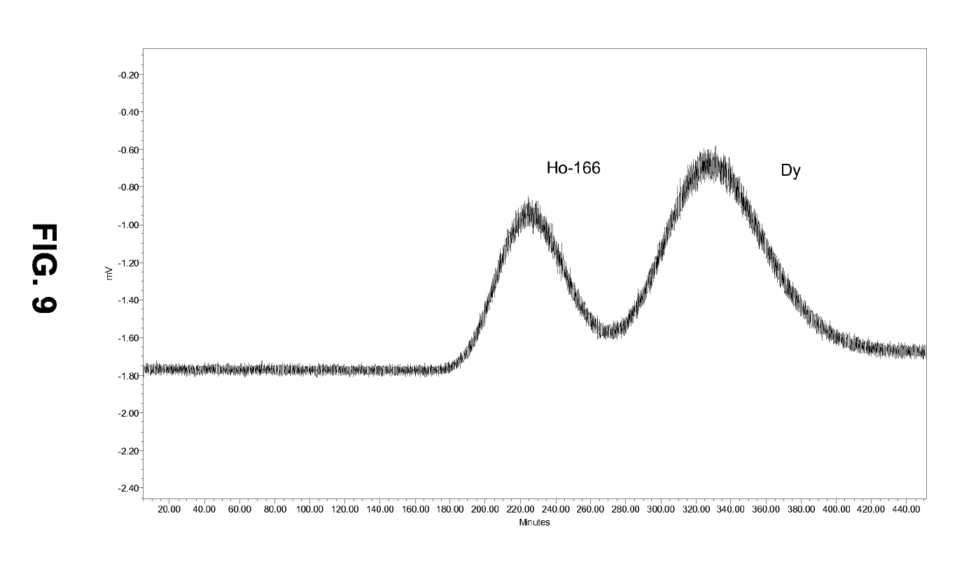

A HPLC column packed with AG 50WX12 200-400 mesh (Bio-Rad) was loaded with a sample containing ¹⁶⁶Ho and Dy. A mobile phase having a composition of 34% water and 66% 0.2 M HIBA at a pH of 4.2 (0.132 M equivalent) was introduced into the HPLC column at a flow rate of 0.8 ml/min and a pressure of approximately 120 psi. After about one hour, the lanthanides had shown little movement down the column, and the composition of the mobile phase was changed to 25% water and 75% HIBA (0.15 M equivalent) and again little movement of the lanthanides down the column was observed after 10 additional minutes. After 90 minutes, the mobile phase composition was changed to 100% HIBA and the flow rate was increased to 1.2 ml/min after 100 minutes. FIG. 9 is a summary of the elution showing the elution of Ho only from about 180 minutes to about 280 minutes, and the elution of Dy from about 280 minutes to about 420 minutes.

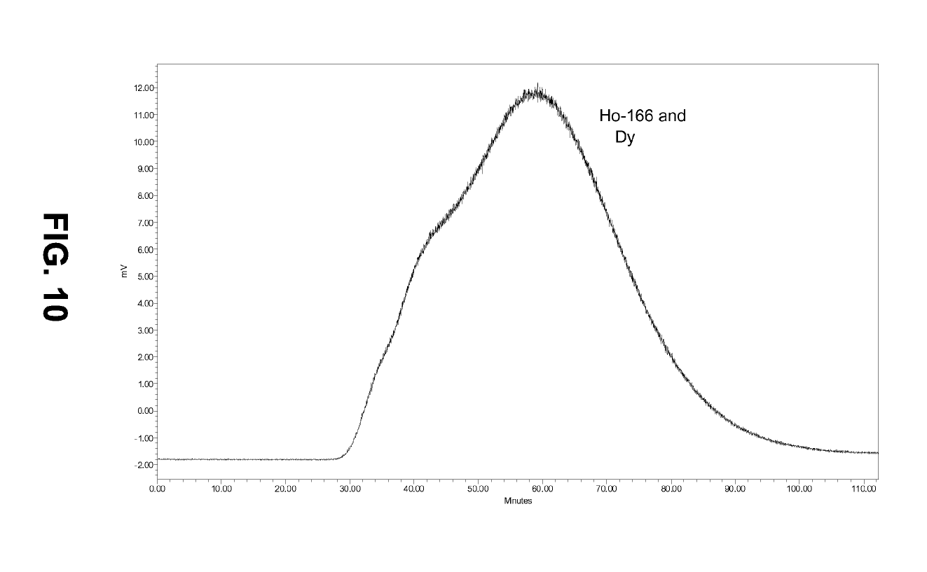

The HPLC column packed with AG 50WX12 200-400 mesh (Bio-Rad) was loaded with a sample containing ¹⁶⁶Ho and Dy. A mobile phase having a composition of 34% water and 66% 0.2 M HIBA at a pH of 4.3 (0.264 M equivalent) was introduced into the HPLC column at a flow rate of 0.8 ml/min and a pressure of approximately 132 psi. FIG. 10 is a summary of the elution showing the simultaneous elution of Ho and Dy from about 28 minutes to about 100 minutes.

The results of this study demonstrated that the efficacy of the HPLC separation is sensitive to the composition of the cation exchange media used as the stationary phase, and to the composition of the mobile phase. Although the mobile phase composition may be adjusted to compensate for the lanthanide retention characteristics of the stationary media composition, the HPLC separation method may be most sensitive to the stationary phase composition.

Having described the invention in detail, it will be apparent that modifications and variations are possible. Those of skill in the art should, in light of the present disclosure, appreciate that many changes could be made in the specific embodiments that are disclosed and still obtain a like or similar result without departing from the spirit and scope of the invention, therefore all matter set forth is to be interpreted as illustrative and not in a limiting sense.

1. A method of separating a lanthanide from a mixture comprising the lanthanide and at least one other lanthanide, comprising:
a. loading the mixture into a HPLC chromatography column comprising a metal-free cationic exchange media;
b. introducing a mobile phase into the HPLC chromatography column, wherein the mobile phase comprises an acid chosen from α-HIBA, citrate, α-H-α-HIBA, α-H-α-MBA, lactic acid, and combinations thereof; and,
c. collecting an eluate comprising the lanthanide from the HPLC chromatography column.

2. The method of claim 1, wherein the method further comprises removing the lanthanide from the eluate.

3. The method of claim 2, wherein the lanthanide is removed from the eluate by:
d. loading the eluate into a second chromatography column comprising an extraction chromatographic material, wherein the extraction chromatographic material has a high affinity for the lanthanide in the eluate and a low affinity for the lanthanide in a second mobile phase;
e. introducing the second mobile phase into the second chromatography column, wherein the second mobile phase comprises a dilute acid selected from HCl, HNO₃, boric acid, and combinations thereof; and,
f. collecting a second eluate from the second chromatography column comprising the lanthanide.

4. The method of claim 1, wherein the lanthanide is a radiolanthanide.

5. The method of claim 4, wherein the at least one other lanthanide comprises a parent isotope of the radiolanthanide, a radiolanthanide by-product, a radiolanthanide decay product, and combinations thereof.

6. The method of claim 3, wherein the dilute acid comprises 0.05 M HCl.

7. The method of claim 3, wherein the volume of the second eluate is less than 1 ml.

8. The method of claim 1, wherein the mobile phase comprises α-HIBA at a concentration ranging from about 0.1 M to about 0.25 M and wherein the pH of the mobile phase ranges from about 3 to about 5.

9. The method of claim 1, wherein the mixture further comprises uranium, isotopes resulting from the fission of uranium, and combinations thereof.

10. The method of claim 1 wherein the method further comprises collecting a third eluate comprising one of the other lanthanides.

11. The method of claim 10, wherein one other lanthanide is the parent isotope of the lanthanide.

12. The method of claim 4, wherein the radiolanthanide is selected from any radioactive isotope of La, Ce, Pr, Nd, Pm, Sm, Eu, Gd, Tb, Dy, Ho, Er, Tm, Yb, or Lu.

13. The method of claim 12, wherein the radiolanthanide is selected from Lu-177, Sm-153, Ho-166, or Tb-161.

14. The method of claim 1, wherein each of the other lanthanides is selected from any stable or radioactive isotope of La, Ce, Pr, Nd, Pm, Sm, Eu, Gd, Tb, Dy, Ho, Er, Tm, Yb, or Lu.

15. A method of producing a radiolanthanide composition having a volume of less than about 1 ml, the method comprising separating a radiolanthanide from a mixture comprising the radiolanthanide and at least one other lanthanide by:
g. loading the mixture into a HPLC chromatography column comprising a metal-free cationic exchange media;
h. introducing a mobile phase into the HPLC chromatography column, wherein the mobile phase comprises an acid selected from α-HIBA, citrate, α-H-α-HIBA, α-H-α-MBA, lactic acid, and combinations thereof;
i. collecting an eluate comprising the radiolanthanide and the mobile phase from the HPLC chromatography column;
j. loading the eluate into a second chromatography column comprising an extraction chromatographic material;
k. introducing a second mobile phase into the second chromatography column, wherein the second mobile phase comprises a dilute acid selected from HCl, HNO₃, boric acid, and combinations thereof; and,
l. collecting the radiolanthanide composition as it elutes from the second chromatography column.

16. A method of separating a lanthanide from a mixture comprising the lanthanide and at least one other lanthanide, comprising:
m. loading the mixture into a HPLC chromatography column comprising a metal-free cationic exchange media;
n. introducing a mobile phase into the HPLC chromatography column, wherein the mobile phase comprises α-HIBA having a concentration ranging from about 0.1 M to about 0.25 M and the pH of the mobile phase ranges from about 3 to about 5; and,
o. collecting an eluate comprising the lanthanide and the α-HIBA from the HPLC chromatography column.

17. The method of claim 16, further comprising:
p. loading the eluate into a second chromatography column comprising an extraction chromatographic material, wherein the extraction chromatographic material has a high affinity for the lanthanide in the eluate and a low affinity for the lanthanide in a second mobile phase;
q. introducing the second mobile phase into the second chromatography column, wherein the second mobile phase comprises 0.05 M HCl; and,
r. collecting a second eluate from the second chromatography column comprising the lanthanide.
